(19) United States
(12) Patent Application Publication
(10) Pub. No.: US 2017/0232691 A1
(43) Pub. Date: Aug. 17, 2017

(54) THERMOSET COMPOSITE WITH SURFACE VEIL LAYER AND METHOD FOR MAKING THE SAME

(71) Applicant: Xamax Industries, Inc., Seymour, CT (US)

(72) Inventors: Robert Markowski, Wallingford, CT (US); Martin Weinberg, New Canaan, CT (US); James Yuan, Westport, CT (US)

(21) Appl. No.: 15/503,333

(22) PCT Filed: Aug. 11, 2015
(86) PCT No.: PCT/US15/44693

§ 371 Date: Feb. 10, 2017

Related U.S. Application Data
(60) Provisional application No. 62/035,711, filed on Aug. 11, 2014.

(51) Int. Cl. B29C 70/52; B29B 15/12; B29C 53/56

(52) U.S. Cl. CPC B29C 70/52; B29C 53/56; B29B 15/122; B29K 2105/0845

(57) ABSTRACT

A thermoset composite (10) and method for producing the same is provided. The method includes: providing at least one surface veil layer (12) that includes a fibrous layer saturated with a water based binder, and one or more composite constituent layers (11); applying an amount of thermoset resin to the composite constituent layers; arranging the surface veil layer and the composite constituent layers in a stack; and producing the thermoset composite by pulling the composite constituent layers and the surface veil layer through a forming die.

The present application is entitled to the benefit of and incorporates by reference essential subject matter disclosed in the U.S. Provisional Patent Application Ser. No. 62/035,711, filed Aug. 11, 2014.

### BACKGROUND INFORMATION

A thermoset composite may be manufactured to include a resin system (e.g., epoxy, vinyl ester, polystyrene, etc.) integrated with one or more reinforcement layers (e.g., woven fiberglass, fiberglass roving, chopped fiberglass, random fiberglass matte, etc.). When the resin is cured, the reinforcement layers provide the thermoset composite with a defined configuration and structural integrity. A thermoset composite can be formed by combining the constituents of the composite using known processes such as, but not limited to, pultrusion and filament winding (sometimes referred to as “mandrel winding”).

Pultrusion processes typically include drawing a stream of a constituent layer (or combined constituent layers) from a roll or other source configuration. The stream (or streams) is subjected to a resin impregnation system and tooling that organizes the constituent layers into a desired configuration. In some instances, the pultrusion process may include disposing a surface veil material on an exterior surface(s) of the web formed by the constituent layer(s). Further downstream, the web may be drawn through a heated forming die; e.g., a die that may have several different temperature zones through-out its length. The resin within the impregnated web material layers cures as the layers travel through the die, finally exiting the die as a cured pultruded fiber reinforced polymer (FRP) composite. A “gripper” system may be used to pull the composite through the pultrusion die on a continuous basis.

Filament winding processes (sometime referred to as “mandrel winding”) typically involve winding filaments under tension around a mandrel. The mandrel rotates and the fibers (which may be resin saturated or coated) are controlled to lay down in a desired orientation and position. The composite product produced by the filament winding process may include one or more surface veil layers; e.g., integrated with the composite to become an interior and/or an exterior surface. Subsequently, the covered mandrel may be subjected to a thermal process that allows the resin to cure and thereby solidify the composite. The mandrel may be removed after the composite is solidified,

The physical characteristics of currently available surface veil materials often limit the production speeds and product throughput of a thermoset composite that includes such a surface veil material. The failure of a surface veil material during production of a thermoset composite (e.g., within a closed die system) can have a significant undesirable impact; e.g., observed failures include composite materials jammed within a die, poor surface veil layer coverage due to stretching of the surface veil material, surface veil tearing or breaking, surface blistering caused by surface veil melting or softening, etc., which can in turn cause a production line to shut down.

### BRIEF SUMMARY

According to an aspect of the present disclosure, a method for producing a thermoset composite is provided. The method includes: a) providing at least one surface veil layer that includes a fibrous layer saturated with a water based binder; b) providing one or more composite constituent layers; c) applying an amount of thermoset resin to at least one of the one or more composite constituent layers; d) arranging the at least one surface veil layer and the one or more composite constituent layers in a stack, which stack is configured such that the at least one surface veil layer is disposed outside of an exterior surface of the one or more composite constituent layers; and e) producing the thermoset composite by pulling the one or more composite constituent layers and the at least surface veil layer through a forming die, which die is configured to cause the thermoset resin to migrate within the stack, including into and through the at least one surface veil layer, and which forming die includes a thermal source adequate to at least partially cure the resin disposed within the stack.

In further embodiments of the foregoing aspect, the water based binder includes at least one of an acrylic latex, a vinyl acrylic, vinyl acetate ethylene, or polyvinyl acetate; the fibrous layer is a non-woven, and may be a spunlaced non-woven, and further may be a spunlaced non-woven having a weight in the range of about seventeen to thirty-five grams per square meter (17-35 g/m²); the fibrous layer may contain at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers; the surface veil layer may include water based binder in the range of about one-half to twelve percent (0.5-12%) by weight, and may include water based binder in the range of about five to nine percent (4-9%) by weight; and the water based binder is adhered to fiber surfaces within the fibrous layer in a cross-linked form, and any combination of the above elements and characteristics.

According to another aspect of the present disclosure, a method for producing a surface veil layer for a thermoset composite is provided. The method includes: a) providing a fibrous layer; b) saturating the fibrous layer with a water based binder; and c) drying the saturated fibrous layer to dry the binder in a cross-linked form on fiber surfaces within the fibrous layer.

In further embodiments of the foregoing aspect, the water based binder includes at least one of an acrylic latex, a vinyl acrylic, vinyl acetate ethylene, or polyvinyl acetate; the fibrous layer is a spunlaced non-woven; the spunlaced non-woven has a weight in the range of about seventeen to thirty-five grams per square meter (17-35 g/m²); the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers; and the dried surface veil layer includes water based binder in the range of about one-half to twelve percent (0.5-12%) by weight, and any combination of the above elements and characteristics.

According to another aspect of the present disclosure, a surface veil layer for a thermoset composite is provided that includes a fibrous layer saturated with a water based binder. The surface veil layer includes water based binder in the range of about one-half to twelve percent (0.5-12%) by weight.

In further embodiments of the foregoing aspect, the water based binder includes at least one of an acrylic latex, a vinyl acrylic, vinyl acetate ethylene, or polyvinyl acetate; the fibrous layer is a spunlaced non-woven; the spunlaced non-woven has a weight in the range of about seventeen to thirty-five grams per square meter (17-35 g/m²); the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers; and the water based binder is adhered to fiber surfaces within the fibrous layer in a cross-linked form, and any combination of the above elements and characteristics.

According to another aspect of the present disclosure, a thermoset composite is provided that includes at least one surface veil layer that includes a fibrous layer saturated with a water based binder, and one or more composite constituent layers, wherein the at least one surface veil layer and the one or more composite constituent layers are arranged in a stacked configuration such that the at least one surface veil layer is disposed outside of an exterior surface of the one or more composite constituent layers, and an amount of cured thermoset resin disposed throughout the stack, including into and through the at least one surface veil layer with thermoset resin disposed on an exterior surface of the surface veil layer.

In further embodiments of the foregoing aspect, the water based binder includes at least one of an acrylic latex, a vinyl acrylic, vinyl acetate ethylene, or polyvinyl acetate; the fibrous layer is a spunlaced non-woven; the spunlaced non-woven has a weight in the range of about seventeen to thirty-five grams per square meter (17-35 g/m²); the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers; and the water based binder is adhered to fiber surfaces within the fibrous layer in a cross-linked form, and any combination of the above elements and characteristics.

According to another aspect of the present disclosure, a method for producing a thermoset composite is provided. The method includes: a) providing at least one surface veil layer stream that includes a fibrous layer saturated with a water based binder; b) providing one or more composite constituent filaments; c) applying an amount of thermoset resin to at least one of the one or more composite constituent filaments; d) wrapping the one or more composite constituent filaments around a mandrel to form at least one filament layer; e) wrapping the at least one surface veil layer stream on top of the filament layer to form at least one surface veil layer; and f) subjecting the wrapped mandrel to an elevated temperature for a period of time, which temperature and time is adequate to cause the thermoset resin to migrate within the layers, including into and through the at least one surface veil layer, and cure the thermoset resin.

According to another aspect of the present disclosure, a method for producing a thermoset composite is provided. The method includes: a) providing at least one surface veil layer that includes a spunlaced non-woven fibrous layer has a weight in the range of about seventeen to thirty-five grams per square meter (17-35 g/m²); b) providing one or more composite constituent layers; c) applying an amount of thermoset resin to at least one of the one or more composite constituent layers; d) arranging the at least one surface veil layer and the one or more composite constituent layers in a stack, which stack is configured such that the at least one surface veil layer is disposed outside of an exterior surface of the one or more composite constituent layers; and e) producing the thermoset composite by pulling the one or more composite constituent layers and the at least surface veil layer through a forming die, which die is configured to cause the thermoset resin to migrate within the stack, including into and through the at least one surface veil layer, and which forming die includes a thermal source adequate to at least partially cure the resin disposed within the stack.

### BRIEF DESCRIPTION OF THE DRAWINGS

FIG. 1 is a diagrammatic illustration of a thermoset composite.

FIG. 2 is a diagrammatic illustration of a system for producing the present surface veil layer.

FIG. 3 is a flow diagram illustrating an exemplary process for forming the present surface veil layer.

FIG. 4 is a diagrammatic illustration of a pultrusion system for producing a thermoset composite with surface veil layers.

FIG. 5 is a diagrammatic illustration of a filament winding system for producing a thermoset composite having surface veil layers.

FIG. 6 is a diagrammatic illustration of an alternative process for removing excess water based binder that includes a pair of rollers.

### DISCLOSURE OF THE INVENTION

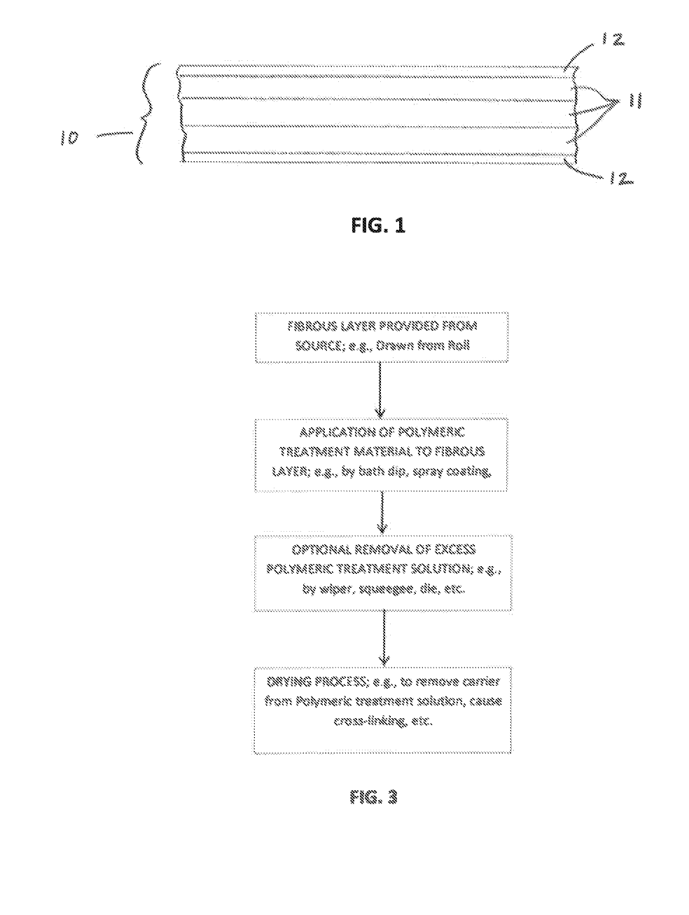

Aspects of the present disclosure include an improved surface veil layer, a thermoset composite that includes the improved surface veil layer, and methods for making the same. As will be described below and as is seen in FIG. 1, the thermoset composite 10 typically includes a plurality of constituent layers 11 (at least some of which are fibrous reinforcement material layers) with one or more surface veil layers 12 disposed on the exterior (i.e., exposed) surfaces of the thermoset composite 10. FIG. 1 diagrammatically illustrates a composite in a planar configuration, but the present disclosure is not limited to such configurations.

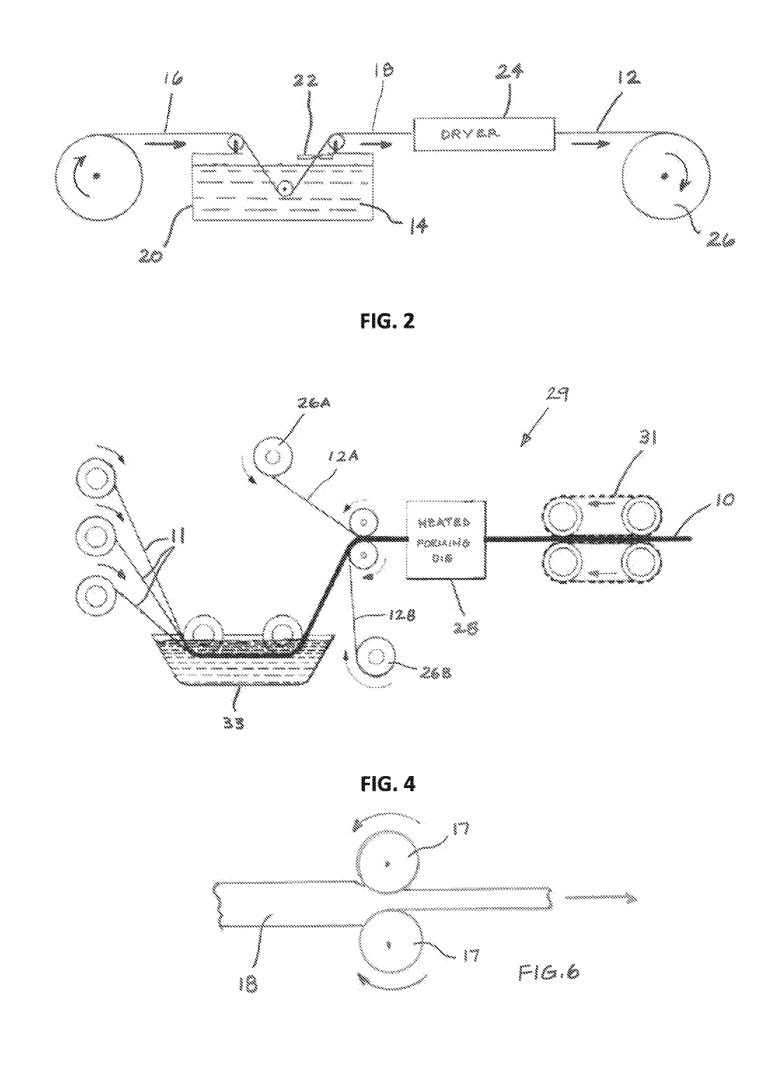

The improved surface veil layer 12 includes a fibrous layer 16 and a water based binder 14 applied to the fibrous layer 14 (e.g., see FIG. 2). As will be described below, the term “applied to” as used herein to describe the addition of the water based binder 14 to the fibrous layer 16 contemplates a variety of different processes for adding the water based binder 14 to the fibrous layer 16, and is not limited to any particular additive process.

Non-limiting examples of the fibrous layer 16 include one or more fibrous materials; e.g., in a woven or a non-woven configuration. The fibrous materials may include, but are not limited to, polymeric fibrous materials such as one or more of the following: polyethylene terephthalate (“PET”) fibers, polyamide (“FA”) family fibers, polyurethane (“PU”) fibers, or acrylic fibers, aramid fibers, carbon fibers, Halar® fibers, basalt fibers, etc. The fibrous material may be formed into a unitary body (e.g., in sheet form or filament group form) using variety of different processes, which unitary body may be processed further to create the present surface veil layer 12. In terms of a non-woven configuration, the fibrous layer 16 may be formed for example using a spunlace process, a flat bond spunbond process, a spinlace process, a point bond spunbond process, a needle punch process, a thermoplastic and thermoplastic bi-component bonding process, a chemical or bonding process, a thermal bonding process, etc. As will be explained below, a non-woven fibrous material formed using a spunlace process, which material has a weight in the range of about seventeen to thirty-five grams per square meter weight (17-35 g/m²), is particularly useful. An example of an acceptable woven configuration is scrim having fixed (e.g., melted or fused) edges.

The water based binder 14 applied to the fibrous layer 16 includes, but is not limited to, an acrylic latex, a vinyl acrylic, a vinyl acetate ethylene (“VAE”), or a polyvinyl acetate (“PVAc”), or combinations thereof. Any of these materials alone or in combination may form the water based binder by itself. As will be described below, the present surface veil layer is intended to be included within a thermoset composite that typically includes a solvent based thermoset resin. The water based binder 14 is substantially non-reactive with the thermoset resin used within the thermoset composite formation process. The water based binder 14 is typically an aqueous solution (e.g., the aqueous solution acts as a carrier for materials within the binder) to facilitate application of the water based binder 14 onto the fibrous layer 16.

In some embodiments, the water based binder 14 may include one or more constituents that improve the performance of and/or manufacturing of the surface veil layer 12, and/or the manufacturability of thermoset composites that include the surface veil layer 12. For example, in some embodiments the water based binder 14 may include one or more additives to protect against damage (e.g., fading, discoloring, chalking, crazing, cracking, etc.) caused by ultraviolet light (“UV”), UV additives can operate to protect the laminate by absorbing UV light, and thereby protecting against the aforesaid damage. Non-limiting examples of acceptable UV additives include from UV-FAST® P (Huntsman Textile Effects BVBA, Belgium), and acrylic emulsions with UV stabilizers, from Celanese Corporation, Dow Chemical Company, or BASF Corporation. Other additives may be added based on the application of the surface veil layer; e.g., additives operable to improve resistance to chemical degradation of the fibrous layer materials, pigments, surfactants, etc.

The water based binder 14 may be applied to the fibrous layer 16 using a variety of processes, and the present disclosure is not limited to any particular technique. For example, the water based binder 14 may be applied to the fibrous layer 16 using a coating process (e.g., by spray, gravure coating, etc.) or a bath dipping process. An example of a bath dipping process (shown in FIG. 2 and described in FIG. 3) includes subjecting the fibrous layer 16 to the water based binder 14 within a bath 20 (e.g., a container holding an amount of the water based binder in liquid form) for an amount of time sufficient for the fibrous layer 16 to become “saturated”. As used herein, the term “saturated” is intended to mean all fiber surfaces within the fibrous layer 16 being completely coated or nearly completely coated with the water based binder 14, and preferably the web of the fibrous layer containing some amount of the water based binder. In some instances, it may not be possible to completely coat the entire surface area of every fiber within the fibrous layer 16 with the water based binder 14; e.g., some types of fibrous layers have fibers in contact with one another, thereby preventing coating of the fiber surface area in the contact areas. In such instances (or the like), the percentage of the uncoated fiber surface area relative to coated fiber surface area is so small that the fibrous layers in these instances are considered to be “saturated” with the water based binder 14. In those instances where a coating process is used, one or more exposed surfaces of the fibrous layer 16 may be sprayed or otherwise exposed to an amount of the water based binder 14. The spray process preferably applies an amount of water based binder 14 sufficient to saturate (or substantially saturate) the fibrous layer 16 with the water based binder.

Subsequent to the application of the water based binder 14 (e.g., by bath dipping, spraying, etc.), the saturated fibrous layer 18 may be subjected to a process to remove a portion of the water based binder from the saturated fibrous layer 18 (e.g., a squeezing or wiping process, or via a die with a defined geometry) to control the amount of the water based binder 14 residing within the saturated fibrous layer 18. FIG. 2 diagrammatically illustrates a wiping device 22 that engages saturated fibrous layer 18 to remove excess water based binder. FIG. 6 diagrammatically illustrates an alternative removal process wherein a pair of rollers 17 is used to squeeze the saturated fibrous layer 18 to remove excess water based binder 14.

Subsequent to the application of the water based binder 14, the saturated fibrous layer 18 may be subjected to a drying process. FIG. 2 diagrammatically illustrates the saturated fibrous layer 18 passing through a dryer 24. The water based binder typically includes a carrier agent (e.g., water, etc.) that facilitates the application and/or adhesion of the water based binder on the fibrous layer 16. The drying process permits removal of the carrier, adhesion of the water based binder 14 to fibers within the fibrous layer 16, and handling of the surface veil layer 12. The dried fibrous layer exiting the dryer 24 is the surface veil layer 12. Downstream of the dryer 24, the surface veil layer 12 may be collected on a roll 26 for storage and/or handling.

On a weight basis, the dried surface veil layer 12 includes binder in the range of about one-half to twelve percent (0.5-12%) of the overall weight of the surface veil layer 12. Although the specific weight basis percentage of binder to overall surface veil layer 12 may vary within the given range to suit a particular application, it is our experience that a surface veil layer 12 having a binder in the range of five to nine percent (5-9% wgt. basis) is particularly useful for many applications.

The specific water based binder used may be configured to promote cross-linking of one or more materials within the binder. For example, a catalyst may be added to the water based binder 14 that reacts with other constituents within the water based binder to initiate/promote the aforesaid cross-linking; e.g., an acidic catalyst that affects the pH of the binder. The specific catalyst used may, therefore, be selected based on the particular water based binder 14 being used. Furthermore, the water based binder 14 (e.g., with or without the catalyst) may be configured such that cross-linking of binder materials occurs when the saturated fibrous layer 18 is subjected to an elevated temperature for a period of time.

The cross-linked binder on the fiber surfaces can change characteristics of the fibrous layer fibers (e.g., change the surface energy of the fibers) and thereby increase the wettability of the surface veil layer 12, which in turns facilitates resin migration within the surface veil layer 12. The cross-linked binder on the fiber surfaces of the fibrous layer can also improve bonding of the surface veil layer within the thermoset composite and increase the tensile strength of the surface veil layer 12. The aforesaid cross-linking may be accomplished in part or in total within a dryer 24 such as that depicted in FIG. 2.

The present surface veil layer 12 can provide a variety of improvements including, but not limited to, an improved surface finish (e.g., smoothness or flatness) and/or an improved appearance of a thermoset composite 10 that includes the surface veil layer 12, enhanced durability of the surface veil layer 12, and enhanced manufacturability. Some of these improvements result from the fact that the present surface veil layer 12 facilitates the migration of the thermoset resin into and through the surface veil layer 12 during the composite formation process, creating a composite 10 with a surface veil layer 12 with thermoset resin throughout its fibrous layer, as well as an amount of thermoset resin disposed on the exposed surface of the surface veil layer 12; this may also be referred to as a resin rich surface. During the composite formation process, the aforesaid thermoset resin may originate from one or more laminate constituents and/or may be added independently during the composite formation process (e.g., resin added directly within the composite forming die). The migration of the thermoset resin into and through the surface veil layer 12 is facilitated at least in part by the water based binder which coats the fibers of the fibrous layer 16. In regards to the improved surface finish, the facilitated migration of thermoset resin improves the smoothness/flatness of the exposed surface by decreasing the planar irregularities (e.g., risings or depressions) of the thermoset composite. The terms “smooth”, “flat” or “flatness” are used herein to describe the quality of surface as being an even surface without risings or depressions (e.g., planar irregularities). With the acknowledgement that no surface is perfectly flat, the terms “smooth”, “flat”, and “flatness” may be used herein to refer to the relative amount of risings and/or depressions in a surface; e.g., embodiments of the present thermoset composite 10 that include the surface veil layer 12, as described herein, can be formed to have a smoothness/flatness that is greater than similar prior art thermoset composites, and in many instances will appear perfectly smooth/flat to the naked eye. In regards to an improved appearance, the present surface veil layer 12 can reduce unsightly irregularities associated with the reinforcement fiberglass layers of the thermoset composite 10; e.g., surface roughness caused by fibers within the fibrous reinforcement layers, perpendicular surface fibers, surface porosities, etc. Here again, the facilitated migration of thermoset resin within and through the present surface veil layer 12 causes more fibers (from the fibrous layer 16 of the surface veil layer 12 and/or from the fibrous reinforcement layers) to be encased within the thermoset resin, and consequently fewer fibers are exposed on the surface of the thermoset composite laminate 10, which exposed fibers can negatively affect the appearance of the laminate. The enhanced resin encasement of the fibers associated with the present surface veil materials also enhances the durability of the thermoset composite 10; e.g., exposed fibers may be subject to attack from materials with which the thermoset composite 10 comes into contact; e.g., chemicals, etc. Furthermore, in many instances the fibers within the fibrous layer 16 are formed from a thermoplastic material. In the absence of the water based binder, the aforesaid thermoplastic fibers may be compromised within the composite formation process, particularly if elevated temperatures are used during the formation process. The water based binder coating the fibers of the fibrous layer 16 protects the fibers from thermal attack (e.g., softening, weakening, etc.) during the composite formation process, thereby increasing the durability of the surface veil layer 12 during the composition formation process. For example, in those instances wherein a cross-linked binder coats the fibrous layer fibers, the cross-linked binder acts as a thermoset material that will not flow until a binder transition temperature is reached (e.g., until the coating is “burned off”). As a result, the cross-linked binder resides on the fibers and thermally protects them at temperatures that would cause the thermoplastic fibers to soften and potentially melt; i.e., temperatures that may be present during a pultrusion process. In regards to the enhanced manufacturability, as indicated above the present surface veil layer 12 has improved tensile strength relative to surface veil layers made from similar fibrous materials of which we are aware. As a result, the present surface veil layer 12 can be incorporated into a thermoset composite at a higher processing speed that is possible with prior art surface veil materials. Also, thermoset composites produced at higher processing speeds are often subjected to higher processing temperatures. As indicated above, the water based binder of the present surface veil layer 12 provides a thermal barrier to protect the fibers of the fibrous layer 14 (which are typically thermoplastic), protecting them against softening and mechanical weakening, thereby permitting the higher composite processing speeds. Still further, it is our experience that thermoset composites manufactured with the present surface veil layer 12 require less pultrusion force (e.g., the amount of force required to pull the combined composite constituents through the pultrusion forming die). As a result, less energy (e.g., electricity) is required during the pultrusion process, thereby making the pultrusion process less costly. Still further, it is our experience that the present surface veil layer is less susceptible to deformation during a composite forming process such as pultrusion where pulling forces are applied to the surface veil layer, relative to prior art surface veil layers. It is our observation that the present surface veil layer 12 deforms less (i.e., less elongation, less necking down, etc.) during a pultrusion process in contrast to prior art surface veil layers. The present surface veil layer applies more uniformly on the thermoset composite, resulting in a composite with improved surface characteristics.

The above described surface veil layer 12 may be included within a variety of different types of thermoset composite laminates 10, and is not limited to a laminate manufactured by any particular technique. As indicated above, a thermoset composite may be manufactured using a thermoset resin system (e.g., epoxy, vinyl ester, polystyrene, phenolic, etc.) integrated with fibrous reinforcement layers (e.g., woven fiberglass, fiberglass roving, chopped fiberglass, random fiberglass matte, etc.). When the thermoset resin is cured, the fibrous reinforcement layers provide the thermoset composite with a defined configuration and structural integrity. Non-limiting examples of surface veil layers 12 and thermoset composites 10 that include the present surface veil layer 12 are provided in the examples below. These examples are provided to illustrate the utility of the present surface veil layer 12 and the present surface veil layer 12 is not limited thereto.

In a first example, a pair of surface veil layers 12A, 12B according to the present disclosure may be incorporated into a thermoset composite 10 that is formed using a pultrusion-type continuous process. FIG. 4 diagrammatically illustrates a non-limiting example of a pultrusion-type process system 29 for forming a thermoset composite 10. In this example, each of the surface veil layers 12A, 12B are formed from a fibrous layer in the form of a spunlace non-woven that includes one or more of PET fibers, PA family fibers, PU fibers, acrylic, or basalt fibers. The water based binder 14 is applied to the fibrous layer 16 in a bath dipping process (e.g., see FIG. 2). During the bath dipping process, the fibrous layer 16 is saturated with the water based binder (e.g., by directing the fibrous layer 16 through a bath 24 containing water based binder), then may be subjected to a process to remove any excess water based binder 14 that may be present (e.g., by a wiping device 22 having wipers, rollers, squeegees, a die, etc.). Subsequently, the surface veil layer 12 is dried to remove the carrier portion of the water based binder; e.g., passed through a dryer 24. In those instances wherein the water based binder is configured to be cross-linked, the aforesaid drying step can also be configured (e.g., temperature, dwell time, etc.) to accomplish or complete the desired cross-linking of the residual binder coating the fibers. The dried surface veil layer 12 may be produced and stored for subsequent incorporation into the thermoset composite laminate 10 (e.g., FIG. 2 illustrates the dried surface veil layer 12 being collected on a roll 26, and FIG. 4 illustrates an interior surface veil layer 12A and an exterior surface veil layer 12B being removed from independent rolls 26A, 26B and subsequently being fed into a laminate forming die 28), or the above described process may be integral to the continuous manufacturing of the thermoset composite laminate 10.

During the pultrusion process, streams of the constituent layers (e.g., one or more of fibrous reinforcement material layers, body layers, backing layers, surface veil layer(s), etc.) that ultimately form the thermoset composite 10 are fed (e.g., from rolls) into a die 28. As indicated above, in the exemplary configuration shown in FIG. 4 two independent surface veil layers 12A, 12B are added upstream of the forming die 28. Downstream of the die exit, a “gripper” system 31 (sometimes referred to as a “puller”) may be used to pull the formed thermoset composite 10 (and therefore the collective layers of the composite from their various sources) from the exit of the forming die 28, thereby providing at least a portion of the requisite motive force to continuously move (e.g., pull) the thermoset composite 10 through the manufacturing process.

The fibrous reinforcement material layer of the thermoset composite may assume a variety of different forms and materials; e.g., woven/non-woven fiberglass, fiberglass roving, chopped fiberglass, random fiberglass matte, etc. Specific examples of material that comprises the fibrous reinforcement material layer include fiberglass, carbon, para aramid (e.g., Kevlar®), meta Aramid (e.g., Nomex®), basalt or the like, and mixtures thereof. A thermoset resin is applied to the fibrous reinforcement material layer in a manner that causes the aforesaid layer to become impregnated (e.g., saturated) with the thermoset resin. For example, in a continuous pultrusion process, the fibrous reinforcement material layer may be impregnated with the thermoset resin by guiding the fibrous reinforcement material layer through a bath 33 of thermoset resin or spray coating the fibrous reinforcement material layer with the thermoset resin, upstream of the forming die 28. Alternatively, the thermoset resin may be directly applied to the fibrous reinforcement material layer within the thinning die 28. The resin impregnation process may occur during the continuous composite formation process, or the fibrous reinforcement material layer may be partially or completely resin impregnated prior to the composite formation process. In those instances wherein the fibrous reinforcement material layer is partially resin impregnated prior to the composite formation process, additional thermoset resin may be added to the fibrous reinforcement material during the composite formation process.

A variety of different thermoset resins may be used (including combinations thereof), with the specific thermoset resin(s) being chosen for the application at hand. In sonic embodiments, additional materials (e.g., fillers, catalysts, pigments, ultraviolet (“UV”) inhibitors, etc.) may be included with the thermoset resin. Regardless of where or how the fibrous reinforcement material is impregnated with thermoset resin, the fibrous reinforcement material layer becomes impregnated to the extent necessary for the formation of the end product thermoset composite 10.

Upstream of the forming die 28, the constituent layers of the composite, including the surface veil layer(s) are fed into the forming die 28 in a stacked configuration that reflects the final layer configuration of the thermoset composite 10; e.g., the surface veil layers are disposed within the stack so that each surface veil layer is disposed on an exterior surface(s) of the thermoset composite 10; i.e., the surface veil layers 12A, 12B are disposed outside of the fibrous reinforcement material.

The forming die 28 typically has several different temperature zones disposed lengthwise within the die 28 that elevate the temperature of the composite constituent layer stack traveling through the die 28. As the constituent layer stack is drawn through the die 28, the thermoset resin(s) within the constituent layers (and/or resin directly added to the forming die 28) migrates throughout the layer stack. A portion of thermoset resin migrates into and through the fibrous layer 16 of each surface veil layer 12A, 12B. As a result, some amount of the thermoset resin is disposed on the exterior surface of the thermoset composite 10, thereby creating a resin rich exterior surface. The surface veil layer 12 provides a barrier that maintains a significant majority of the fibers of the reinforcement material layers remain below the surface veil layers 12A, 12B. As a result, substantially all of the texture (e.g., surface irregularities) of the fibrous reinforcement material layer(s) is prevented from telegraphing through to the exterior surface of the composite 10. To the extent that some of the fibers of the reinforcement material layers are oriented to extend through one or both surface veil layers 12A, 12B during the formation of the composite 10, the resin rich exterior surface of the composite 10 encases many of those fibers, thereby protecting them and enhancing the exterior surface finish of the composite 10. The binder of each surface veil layer 12A, 12B also enhances the composite surface finish making the fibrous layer 16 less “fuzzy”. To the extent that some of the fibers of the fibrous layer 16 are oriented toward the exterior surface of the composite 10, the resin rich exterior surface of the composite 10 encases many of those fibers, thereby protecting them and enhancing the exterior surface finish of the composite 10.

It is our experience that the incorporation of water based binder within the surface veil layer 12 provides shielding, thermal insulation, and abrasion protection to the fibers within the fibrous layer of the surface veil layer 12. The term “abrasion resistance” is used to describe that water based binder protects the fibers within the surface veil layer 12 from abrasion damage as the composite materials are drawn through the die. In addition, as indicated above a thermoset composite that includes the present surface veil layer 12 can be pulled in a pultrusion process using less energy than is possible relative to a composite that includes prior art surface veil materials of which we are aware; i.e., the present surface veil layer 12 including the water based hinder is believed to act as a “lubricant” during the pultrusion process. As a result, the surface veil layer 12 can be processed within a pultrusion-type composite formation process at higher processing parameters (e.g., temperature, pressure, and/or tension) than are typically used in the prior art, without degradation; e.g., mechanical failure of fibrous layer fibers, and/or premature softening/melting of fibrous layer fibers, which can potentially cause jamming and sheet/web failure within the forming die 28, are substantially avoided. In addition, the water based binder (which improves the wettability of the surface veil layer 12) helps to improve the migration of the thermoset resin through the surface veil layer 12 to the surface of the composite, thereby improving the surface finish and smoothness of the composite 10. The improved migration of the thermoset resin through the present surface veil layer 12 is another factor that makes it possible to process the thermoset composite 10 at a higher processing speed; less time is required in the forming die 28, which makes it possible to increase the processing speed. Still further, in many instances it is desirable to perform a surface preparation step (e.g., sanding) of a composite exterior surface, particularly when the composite is formed using a filament winding process. It is our experience that a composite that incorporates a surface veil layer 12 according to the present disclosure can be subjected to a surface preparation step with less “fiber bloom” than typically occurs within prior art laminates. The term “fiber bloom” refers to the exposure of fibers on an exposed surface of the thermoset composite; e.g., fibers from the surface veil layer 12 and/or fibers from the fibrous reinforcement material layers. As indicated above, the water based binder of the surface veil layer 12 makes the fibrous layer 16 less “fuzzy”, and also promotes a resin rich exterior surface of the composite 10, which resin rich surface encases fibers (from the fibrous layer 16 and/or the fibrous reinforcement material layers within the composite). Consequently, thermoset composites using the present surface veil layer 12 often require less post processing surface preparation, and to the extent such surface preparation is performed, less fiber bloom occurs.

In a second embodiment, the above described continuous process (e.g., the constituent layers of the thermoset composite 10, including the surface veil layer(s) 12 are fed into the forming die 28 in a stacked configuration) may be followed using a surface veil layer 12 that is formed using a fibrous layer formed as a spunbond non-woven. In this embodiment, the spunbond fibrous layers may comprise one or more of the fibrous materials described above.

In a third embodiment, the above described process (e.g., the constituent layers of the thermoset composite 10, including the surface veil layer(s) 12 are fed into the forming die 28 in a stacked configuration) may be followed using a surface veil layer 12 that is formed using a fibrous layer formed as a spinlace non-woven. In this embodiment, the spinlace fibrous layers may comprise one or more of the fibrous materials described above.

In a fourth embodiment, the above described process (e.g., the constituent layers of the thermoset composite 10, including the surface veil layer(s) 12 are fed into the forming die 28 in a stacked configuration) may be followed using a surface veil layer 12 that is formed using a fibrous layer formed from fibers that are treated with a water based binder prior to the formation of the fibrous layer.

In a fifth embodiment, the above described process may be followed using a spunlaced surface veil layer 12 (comprising one or more fiber materials described above) having a weight in the range of about seventeen to thirty-five grams per square meter (17-35 g/m2), without a water based binder. Prior art spunlaced surface veil materials of which we are aware typically have a weight in the range of 37-54 g/m². It is our experience that a spunlaced surface veil material according to the present disclosure permits the use of a thinner, lighter weight surface veil layer 12 within a pultrusion process. The ability of the present surface veil layer 12 to be used in a thinner, lighter configuration significantly decreases the cost of forming the thermoset composite 10 and facilitates migration of the thermoset resin into and through the surface veil layer 12 to create a more resin rich surface; e.g., the distance the resin must migrate when passing through the surface veil layer 12 (e.g., having a non-woven fibrous layer) is less than prior art surface veil layers of which we are aware. In this embodiment, the spunlaced surface veil layer 12 having a weight in the range of about seventeen to thirty-five grams per square meter (17-35 g/m2) may be used with or without a water based binder.

In alternative embodiments, a surface veil layer material according to the present disclosure, can be used within a filament winding (also referred to as “mandrel winding”) process to produce a thermoset composite 10. In this example, filaments that ultimately form the fibrous reinforcement material layer of the laminate are wound under tension around a mandrel. The mandrel rotates and the fibers (which may be resin saturated or coated) are controlled to lay down in a desired orientation and position. Once the appropriate composite materials are wound around the mandrel, a surface veil layer (in filament or sheet form) may be added to the composite (the surface veil may also be placed on the surface contacting the mandrel as well). Subsequently, the covered mandrel may be subjected to a thermal process that allows the resin to migrate and cure and thereby solidify the product. The mandrel is removed after the composite is solidified.

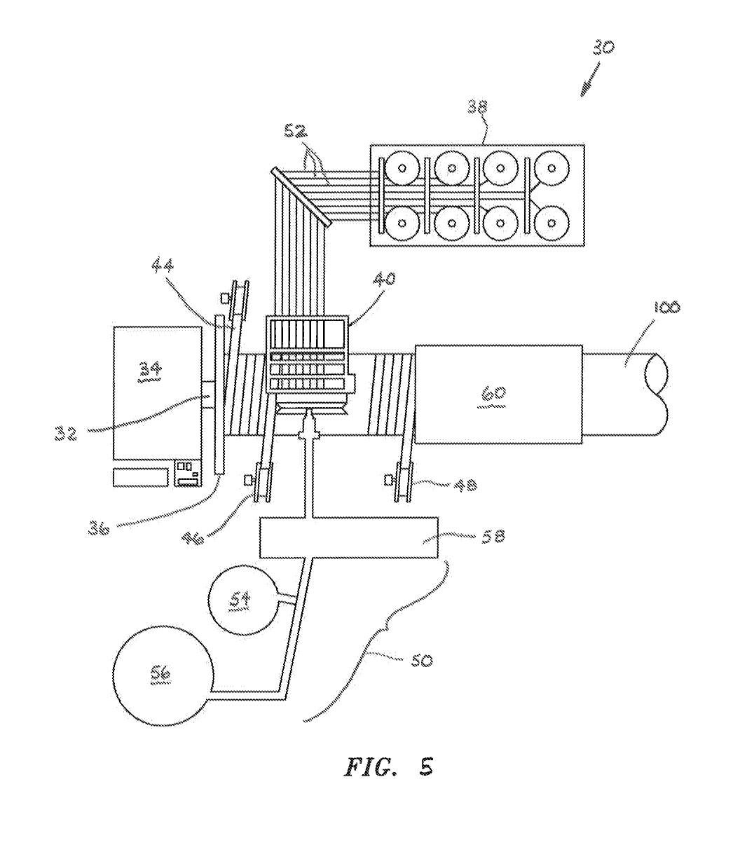

The present surface veil layer 12 may be used in a variety of different filament winding processes and is therefore not limited to any particular process. To illustrate how the present surface veil layer 12 may be incorporated into a particular thermoset composite, the following example is provided. A thermoset composite pipe 100 with an interior surface and an exterior surface may be manufactured using a filament winding process. FIG. 5 diagrammatically illustrates a filament winding apparatus 30 that includes a spindle 32 connected to a spindle motor 34, a mandrel 36 mounted on the spindle, a roving rack 38, a carriage 40, a curing device 42, a release film spool 44, an interior surface veil layer spool 46, an exterior surface veil layer spool 48, and a resin supply 50. The release film spool 44 is controlled to wrap the mandrel 36 with a release film, which will facilitate the separation of the formed pipe 100 after curing. The interior surface veil layer spool 46 is controlled to wrap the mandrel 36 with the interior surface veil layer (i.e., radially outside of the release tape) previously formed as described above; e.g., in a narrow sheet configuration fed from the spool 46. The roving rack 38 provides a source of the various filaments 52 (e.g., fibrous reinforcement material filaments), which filaments 52 are directed to the mandrel 36 in a predetermined orientation for wrapping around the mandrel on top of (i.e., radially outside of) the interior surface veil layer. The filaments 52 collectively form the fibrous reinforcement material layer(s). As the filaments 52 are wound on the mandrel 36, thermoset resin from the resin supply 50 is applied to the filaments 52. FIG. 5 illustrates a resin supply 50 having two constituent material reservoirs 54, 56, and a device 58 for controlling the rate of resin application. Although FIG. 5 illustrates the release film spool 44, surface veil layer spools 46, 48, the carriage 40, and the resin supply 50 in a single position, these devices may be positionally controlled to move along the axial length of the pipe 100 (and therefore the mandrel 36) to form the length of the pipe. The exterior surface veil layer spool 48 is controlled to wrap an exterior surface veil layer (e.g., previously formed as described above) on top of (i.e., radially outside of) the applied filaments 52. The “stack” of constituents that form the composite pipe 100 (i.e., the interior surface veil layer, the filament windings, and the exterior surface veil layer) are subsequently exposed to the curing device 60 (which typically creates an elevated temperature environment) to cure the thermoset resin and solidify the composite pipe 100. The mandrel 36 and release tape layer are subsequently removed, leaving the composite pipe 100. The curing device 60 may also be positionally controlled to move along the axial length of the composite pipe 100 (and therefore the mandrel 36) to cure the resin within the constituents along the length of the pipe 100. As described above, the thermoset resin migrates during the curing process; i.e., migrates into and through the interior and exterior surface veil layers thereby creating a resin rich surface on each surface veil layer. The above described process illustrates a single exemplary process, and the present disclosure is not limited thereto. For example, the filaments 52 may be drawn through a resin bath prior to being wound on the mandrel 36 in place of the resin supply 50, or in addition to the resin supply 50. Also, in some embodiments, the curing device 60 of the above described filament winding apparatus 30 may be eliminated, and the entire length of pipe 100 and mandrel 36 may alternatively be placed within a separate curing device (e.g., an autoclave oven). The same filament winding process may also be used to create composite structures other than a pipe; e.g., gas tanks, oil tanks, chemical tanks, bulk material tanks, utility poles, flag poles, etc. The geometry of the mandrel 36 (and other filament winding hardware) will reflect the geometry of the composite being produced. After the curing process is completed and the mandrel 36 is removed, the thermoset composite product can, as desired, be subjected to further processing (e.g., sanding, etc.) to create a desired surface finish. As indicated above, the resin rich surfaces created using the present surface veil layer cover and the water based binder of the surface veil layer(s) minimize the potential for fiber bloom during the surface finish processing. A thermoset composite product such as described above (e.g., having interior and exterior surface veil layers with a resin rich surface) is particularly useful for applications where harsh chemicals (that could damage the fibers and other materials within the interior of the laminate) are contained within the composite product, and/or where the exterior of the composite product is likely to be subject to potentially harmful UV light.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure

What is claimed is:

1. A method for producing a thermoset composite, comprising:
providing at least one surface veil layer that includes a fibrous layer saturated with a water based binder;
providing one or more composite constituent layers;
applying an amount of thermoset resin to at least one of the one or more composite constituent layers;
arranging the at least one surface veil layer and the one or more composite constituent layers in a stack, which stack is configured such that the at least one surface veil layer is disposed outside of an exterior surface of the one or more composite constituent layers; and
producing the thermoset composite by pulling the one or more composite constituent layers and the at least surface veil layer through a forming die, which die is configured to cause the thermoset resin to migrate within the stack, including into and through the at least one surface veil layer, and which forming die includes a thermal source adequate to at least partially cure the resin disposed within the stack.

2. The method of claim 1, wherein the water based binder includes at least one of an acrylic latex, a vinyl acrylic, vinyl acetate ethylene, or polyvinyl acetate.

3. The method of claim 2, wherein the fibrous layer is a non-woven.

4. The method of claim 3, wherein the fibrous layer is a spunlaced non-woven.

5. The method of claim 4, wherein the spunlaced non-woven has a weight in the range of about seventeen to thirty-five grams per square meter (17-35 g/m²).

6. The method of claim 1, wherein the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers.

7. The method of claim 1, wherein the surface veil layer includes water based binder in the range of about one-half to twelve percent (0.5-12%) by weight.

8. The method of claim 7, wherein the surface veil layer includes water based binder in the range of about five to nine percent (4-9%) by weight.

9. The method of claim 1, wherein the water based binder is adhered to fiber surfaces within the fibrous layer in a cross-linked form.

10. A method for producing a surface veil layer for a thermoset composite, comprising:
providing a fibrous layer;
saturating the fibrous layer with a water based binder; and
drying the saturated fibrous layer to dry the binder in a cross-linked form on fiber surfaces within the fibrous layer.

11. The method of claim 10, wherein the water based binder includes at least one of an acrylic latex, a vinyl acrylic, vinyl acetate ethylene, or polyvinyl acetate.

12. The method of claim 10, wherein the fibrous layer is a spunlaced non-woven.

13. The method of claim 12, wherein the spunlaced non-woven has a weight in the range of about seventeen to thirty-five grams per square meter (17-35 g/m²).

14. The method of claim 10, wherein the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers.

15. The method of claim 10, wherein the dried surface veil layer includes water based binder in the range of about one-half to twelve percent (0.5-12%) by weight.

16. A surface veil layer for a thermoset composite, comprising:
a fibrous layer, saturated with a water based binder; and
wherein the surface veil layer includes water based binder in the range of about one-half to twelve percent (0.5-12%) by weight.

17. The surface veil layer of claim 16, wherein the water based binder includes at least one of an acrylic latex, a vinyl acrylic, vinyl acetate ethylene, or polyvinyl acetate.

18. The surface veil layer of claim 16, wherein the fibrous layer is a spunlaced non-woven.

19. The surface veil layer of claim 18, wherein the spunlaced non-woven has a weight in the range of about seventeen to thirty-five grams per square meter (17-35 g/m²).

20. The surface veil layer of claim 16, wherein the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers.

21. The surface veil layer of claim 16, wherein the water based binder is adhered to fiber surfaces within the fibrous layer in a cross-linked form.

22. A thermoset composite, comprising:
at least one surface veil layer that includes a fibrous layer saturated with a water based binder, and one or more composite constituent layers, wherein the at least one surface veil layer and the one or more composite constituent layers are arranged in a stacked configuration such that the at least one surface veil layer is disposed outside of an exterior surface of the one or more composite constituent layers; and
an amount of cured thermoset resin disposed throughout the stack, including into and through the at least one surface veil layer with thermoset resin disposed on an exterior surface of the surface veil layer.

23. The thermoset composite of claim 22, wherein the water based binder includes at least one of an acrylic latex, a vinyl acrylic, vinyl acetate ethylene, or polyvinyl acetate.

24. The thermoset composite of claim 22, wherein the fibrous layer is a spunlaced non-woven.

25. The thermoset composite of claim 24, wherein the spunlaced non-woven has a weight in the range of about seventeen to thirty-five grams per square meter (17-35 g/m²).

26. The thermoset composite of claim 22, wherein the fibrous layer contains at least one of polyethylene terephthalate (“PET”) fibers, polyamide (“PA”) family fibers, polyurethane (“PU”) fibers, acrylic fibers, aramid fibers, carbon fibers, Halar® fibers, or basalt fibers.

27. The thermoset composite of claim 22, wherein the water based binder is adhered to fiber surfaces within the fibrous layer in a cross-linked form.

28-29. (canceled)
